(19) United States
(12) Patent Application Publication
(10) Pub. No.: US 2008/0250496 A1
(43) Pub. Date: Oct. 9, 2008

(54) Frame Relay Device

(76) Inventor: Daisuke Namihira, Kawasaki (JP)

Correspondence Address: KATTEN MUCHIN ROSENMAN LLP, 575 MADISON AVENUE, NEW YORK, NY, 10022-2585, US

(21) Appl. No.: 10/571,082

(22) PCT Filed: Oct. 7, 2003
(86) PCT No.: PCT/JP2003/012828

§ 371 Date: Mar. 6, 2006

(51) Int. Cl. H04L 9/32; G06F 12/14

(52) U.S. Cl. 726/22

(57) ABSTRACT

A frame relay device includes a table where an entry containing a combination of an MAC address and an IP address is registered to be used in the frame relay processing of a local device. Moreover, the frame relay device includes judgment means for searching the table by the transmission origin MAC address and the transmission origin IP address contained in the frame received and judging whether the combination of the transmission origin addresses is registered as a relay object in the layer 3. Furthermore, the frame relay device includes layer 3 relay processing means for performing layer 3 relay processing only for the frame which has been judged to contain the combination of the transmission origin addresses as a relay object.

### CROSS-REFERENCE TO RELATED APPLICATION

This is a continuation of Application PCT/JP2003/012828, filed on Oct. 7, 2003, now pending, the contents of which are herein wholly incorporated by reference.

### TECHNICAL FIELD

The present invention relates to a frame relay device, in particular, a frame relay device for preventing an attack to another server or terminal by address spoofing.

### RELATED ART

Conventionally, there is a problem of so-called address spoofing, in which an IP (Internet Protocol) address assigned to each network connection device or a MAC (Media Access Control) address unique to the above-mentioned network connection device is masqueraded as an address of another connection device. Of such address spoofing, IP address spoofing can be easily practiced by, for example, rewriting a source IP address to appropriate someone else's address. Although MAC address spoofing is difficult as compared with the IP address spoofing, it is possible to spoof a MAC address used by someone else. If an attack from a network such as a DoS (Denial of Services) attack or an intrusion from a network is performed on various servers or terminals connected to the Internet after address spoofing, it is difficult to identify a source of the attack or the intrusion because the IP address or the MAC address differs from its proper address.

Normally, in order to prevent address spoofing, a so-called filtering process of sorting frames under a predetermined condition to relay only frames that are required to be relayed is performed. A function of such the filtering process is provided in a firewall, a load distribution device, or a relay device such as a router or a layer 3 switch.

The filtering function provided in a frame relay device as described above determines whether or not information (for example, an IP address or the like) assigned to a header of a frame is to be filtered so as to select a frame to be relayed in order to maintain the original frame relaying performance of the device. Therefore, if an address of the source of an intrusion or an attack is frequently modified by spoofing, such a frame is not filtered when the address after modification is not found in an address table for judging a filtering object. Therefore, spoofing cannot be prevented. On the other hand, if all the frames for a certain service, which are received by the relay device, are to be filtered regardless of their addresses, all the frames for the service are blocked by the relay device. Therefore, there is a possibility that all the terminals accessing a server through the relay device cannot receive the service provided by the server.

Moreover, in the firewall or the load distribution device, it is possible to prevent a frame from an attack source address from being relayed when the attack through a network is detected. However, in the case where an attack persists while a spoofed address is being repeatedly modified or the like, it is difficult to determine whether or not a transmitted frame is an attack frame.

Furthermore, a general firewall is installed at the location where it is connected to an external network such as the Internet. The load distribution device is installed at the location where it is directly connected to a server corresponding to a target of load distribution. In this case, since a network corresponding to a path leading to the firewall or the load distribution device causes congestion with a large amount of attack frames, there arises a problem in that the other frames are not transmitted.

In order to solve such problems, it is necessary to install the firewalls or the load distribution devices in the vicinity of all the terminals so as to eliminate attack frames in close vicinity of the terminals. In consideration of installation cost and work, however, it is difficult to install such devices in the vicinity of all the terminals.

Note that, as a technique of preventing an attack by address spoofing such as IP address or MAC address spoofing as described above, a technique of activation (proving the possession of a legitimate license) to prevent spoofing in address modification with a terminal motion in wireless communication is disclosed (for example, see Patent Document 1).

Patent Document 1

JP 2003-518821 A

The present invention has been made in view of the problems of the conventional techniques as described above. Specifically, an object of the present invention is to provide a technique of preventing a frame from being relayed by address spoofing in a frame relay device such as a router, a layer 3 switch, or a layer 2 switch (a switching HUB).

### Disclosure of the Invention

The present invention adopts the following means to solve the problems described above.

That is, according to the present invention, there is provided a frame relay device including: a table for registering an entry containing a pair of a MAC address and an IP address used in a process of relaying a frame in the frame relay device itself; judging means for searching through the table for a source MAC address and a source IP address in a received frame to judge whether or not the pair of the source addresses is registered as a relay object at a layer 3; and layer 3 relay processing means for performing a layer 3 relay process only for a frame judged as containing the pair of the source addresses registered as the relay object.

According to the frame relay device of the present invention, based on a table for registering an entry in which a relay object contains a pair of a MAC address and an IP address, a process of judging whether or not the relay object is a relay object (a routing object) for the received frame. In the frame relay device of the present invention, a relay process (a routing process) is performed for a frame to be routed. The table is structured such that a pair of a MAC address and an IP address legitimately assigned to a terminal or a relay device is registered whereas a pair of unauthorized addresses including a spoofed MAC or IP address is not registered. Therefore, according to the present invention, of all the received frames, a frame such as a spoofed one, which is not allowed to be relayed, can be prevented from being relayed.

Further, the present invention is preferably constituted by providing relay object registering means for: transmitting a query frame for querying whether or not the pair of the source addresses is normal if the pair of the source addresses of the frame is not registered in the table; judging whether or not a condition that a reply frame to the query frame is received within a predetermined time after the transmission of the query frame and a condition that information in the reply frame indicates that the pair of the source addresses is normal are satisfied; registering an entry containing a pair of source addresses satisfying the conditions in the table; and excluding a pair of source addresses failing to satisfy the conditions from an object to be registered in the table.

According to the frame relay device of the present invention, prior to the registration of the received frame in the table (registration for allowing the routing), the query frame is transmitted. After judging that a reply to the query frame is correct, the frame relay device registers an entry containing a pair of source addresses of the received frame determined to contain a correct combination of source addresses. In this manner, for reception of the frame, for example, a pair of source addresses of a frame having a spoofed address can be prevented from being registered as a relay object.

Further, the relay object registering means of the present invention transmits an ARP (Address Resolution Protocol) request frame for querying a MAC address corresponding to the source IP address of the frame as the query frame to receive an ARP reply frame as the reply frame and may judge that the combination of the source addresses is normal when the MAC address of a query destination in the ARP reply frame is identical with the source MAC address of the frame.

In this manner, since an existing ARP request frame is used as a query frame of the present invention, the process of the present invention can be executed without creating a new query frame.

Further, the relay object registering means of the present invention transmits a ping (Packet INternet Groper) frame containing the source MAC address and the source IP address of the frame respectively as a destination MAC address and a destination IP address as the query frame to receive a ping reply frame as the reply frame and may judge that the combination of the source addresses is normal when the source MAC address and the source IP address of the ping reply frame are respectively identical with the source MAC address and the source IP address of the frame.

In this manner, since an existing ping frame is used as a query frame of the present invention, the process of the present invention can be executed without creating a new query frame.

Further, the relay object registering means of the present invention may exclude the pair of the source addresses of the frame from an object to be registered in the table regardless of whether or not the conditions for the reply frame are satisfied when an entry containing the same IP address as the source IP address of the frame is already registered in the table.

In this manner, a frame having a spoofed MAC address can be prevented from being registered as a relay object in the table.

Further, the relay object registering means of the present invention may exclude the pair of the source addresses of the frame from an object to be registered in the table regardless of whether or not the conditions for the reply frame are satisfied when an entry containing the same MAC address as the source MAC address of the frame is already registered in the table.

In this manner, for example, a frame having a spoofed IP address can be prevented from being registered as a relay object.

Further, the present invention may be constituted such that a registerable number of entries having the same MAC address and a different IP address in the table is predefined; and the relay object registering means eliminates the pair of the source addresses of the frame from an object to be registered in the table regardless of whether or not the conditions for the reply frame are satisfied when the number of entries equal to or larger than the registerable number, each containing the same MAC address as the source MAC address of the frame, are already registered in the table.

According to the present invention, prior to the registration of the pair of source addresses of the frame to be allowed as a relay object in the table, the number of already registered IP addresses corresponding to the same MAC address as the source MAC address of the frame is obtained. Then, if the number of registered IP addresses is equal to or larger than a predefined registerable number of IP addresses for the same MAC address, the registering process is not performed. Therefore, according to the present invention, by setting a plural number as the registerable number, the pair of a MAC address and an IP address in the case where the same terminal modifies its IP address is allowed to be registered in the table. On the other hand, the number of addresses equal to or larger than the registerable number is prevented from being registered to prevent a spoofed address from being registered.

Further, the present invention is constituted such that the table stores an entry containing a MAC address and a destination port number corresponding to the MAC address and constituted by providing a field of an IP address corresponding to the MAC address and a field for storing information indicating whether or not it is a relay object for each entry of the MAC address table referred to so as to find a destination port in the layer 2 relay of a frame, and may be constituted by providing layer 2 relay processing means for referring to the table to perform the layer 2 relay process of a frame received by the frame relay device itself, and deleting means for deleting an entry unused for a given period of time from the table.

According to the present invention, the table for judging whether or not a frame is to be relayed can be incorporated into a MAC address table used in a normal layer 2 relay device. Therefore, according to the present invention, a layer 2 relay process and a routing object check can be performed on a single table. Moreover, automatic entry deletion can be realized by using an aging process for the MAC address table.

Further, according to the present invention, when an entry containing the pair of the source addresses of the frame is to be registered in the table, if another entry containing the same MAC address as the MAC address forming the pair of the source addresses is already registered in the table, the entry may be registered so as to be found in a search prior to the another entry in a process executed by the judging means.

According to the present invention, by a so-called aging process of deleting an entry after elapse of a predetermined time, an entry having an old IP address is automatically deleted. Therefore, according to the present invention, it is ensured that an entry containing an unused IP address can be deleted from the Table.

Further, the present invention may be configured to be capable of setting whether or not the processes executed by the judging means and the relay object registering means are performed for each port included in the frame relay device itself.

In this manner, the process of the present invention can be set to be executed or not in accordance with a connection device to be connected to each port or the conditions of a network.

Further, the present invention can be specified as a framed relay device including: a table capable of registering only one receivable MAC address for each port included in the frame relay device itself; judging means for judging, for a frame received at each port, whether or not a pair of the same MAC address and the same port number as a pair of a source MAC address and a receiving port number of the frame is registered in the table; and relay means for performing a layer 2 relay process only for a frame containing the pair of the source MAC address and the receiving port number judged as being registered.

According to the present invention, in the table defining relay objects, one MAC address is prepared for each port included in the relay device. Moreover, in the present invention, the pair of the MAC address and the receiving port number, which correspond to the source MAC address of the received frame, is searched from the table so that the relay process is executed. Therefore, according to the present invention, in the layer 2 relay process, a frame with a spoofed MAC address can be prevented from being relayed.

Further, the present invention may further include a MAC address learning section of judging whether or not the pair of the source MAC address and the receiving port number is valid so as to register a valid pair of a source MAC address and a receiving port number in the table when the source MAC address of the frame is not registered in the table.

In this manner, the MAC address learning function can be used to register the pair of a MAC address and a port number, which is recognized as valid, in the table. In this case, a pair of a spoofed source MAC address and a receiving port is judged as being invalid to prevent the pair from being registered.

Moreover, it is preferred that the MAC address learning section of the present invention registers a pair of a source MAC address and a receiving port number first received after the port is put into a frame receivable state as the valid pair in the table. In this case, the state occurs for all the ports of the relay device when the relay device is activated. Alternatively, the state occurs when a link to a certain port is broken during the activation of the relay device and then a link is connected to the port.

According to the present invention, the MAC address learning section registers the pair of the source MAC address and the receiving port number of the frame first received from the port as a valid pair in the table so as to relay the frame. Therefore, according to the present invention, a spoofed frame received after the registration of the valid pair in the table can be prevented from being relayed.

Further, according to the present invention, the MAC address learning section may be capable of setting for each port whether or not to judge validity of the pair of the source MAC address and the receiving port number.

In this manner, it is possible to set the process of the present invention to be executed or not in accordance with a device connected to each port or the conditions of a network.

Note that, the present invention can be specified as a program of allowing a computer to realize any one of the functions of the means according to the present invention. Moreover, the present invention can be specified as a recording medium readable by a computer on which such the program is recorded. Furthermore, the present invention can be specified as a device of performing a layer 3 or layer 2 relay judging process.

### BRIEF DESCRIPTION OF THE DRAWINGS

FIG. 1 is a block diagram showing a configuration of a frame relay device according to a first embodiment;

FIG. 2 is a flowchart showing a layer 2 relay process and an example of a MAC address table in a conventional layer 2 switch;

FIG. 3 shows an example of a MAC address table according to the first embodiment;

FIG. 4 is an example of a flowchart showing a layer 2 relay process by a layer 2 relay processing section of the frame relay device;

FIG. 5 is an example of a flowchart for explaining a layer 2 address learning process in a conventional layer 2 switch;

FIG. 6 is an example of a flowchart for explaining a layer 2 address learning process by a layer 2 address learning processing section of the frame relay device;

FIG. 7 is a block diagram showing a configuration of a frame relay device according to a second embodiment;

FIG. 8 is an example of a flowchart for explaining a routing preprocess by a routing object check section;

FIG. 9 is an example of a flowchart for explaining a routing object registering process by a routing object registration processing section; and

FIG. 10A is an example of a flowchart for explaining the routing object registering process by the routing object registration processing section.

FIG. 10B is an example of a flowchart for explaining the routing object registering process by the routing object registration processing section.

### BEST MODE FOR CARRYING OUT THE INVENTION

Hereinafter, an embodiment of a frame relay device of the present invention will be described with reference to the drawings. The frame relay device of the present invention can be applied to a switching hub, a layer 2 switch, a router, a layer 3 switch, a device having a relaying function of both L2 and L3 (an L2/L3 switch), or the like.

In this embodiment, an example of a frame relay device according to the present invention, which is applicable to a layer 2 switch or a switching HUB, will be described as a first embodiment. An example of a frame relay device according to the present invention, which is applicable to a layer 3 switch, a router, or an L2/L3 switch, will be described as a second embodiment.

### First Embodiment

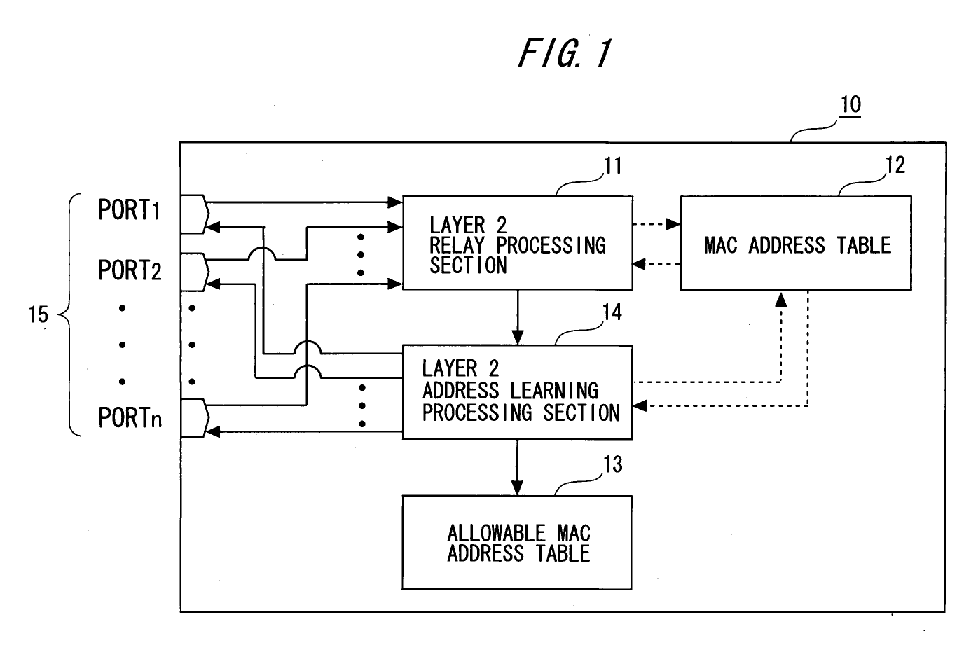

FIG. 1 is a block diagram showing a configuration of a frame relay device according to the first embodiment. A frame relay device 10 includes a layer 2 relay processing section 11, a MAC address table 12, a layer 2 address learning processing section 13, and an allowable MAC address table 14.

Note that, among the functional blocks of the frame relay device 10, the layer 2 relay processing section 11 functions as judging means and relay means of the present invention. The layer 2 address learning processing section 13 functions as judging means, registering means, and switching means of the present invention.

The layer 2 relay processing section 11 receives a frame received by each of a plurality of (for example, n) ports 15. The layer 2 relay processing section 11 refers to the MAC address table 12 so as to execute a layer 2 relay process described below for each frame. The layer 2 relay process determines a destination, to which a frame is relayed. After the layer 2 relay process, the layer 2 relay processing section 11 transmits a frame to the layer 2 address learning processing section 13.

Note that, the layer 2 relay processing section 11 performs a so-called aging process (a process for elapse of time) so as to delete information (an entry) of a frame corresponding to an old search object from the MAC address table 12. In the aging process, if there is no access to an entry after elapse of a predetermined time (for example, normally 30 seconds in the case of an IPv4) from the registration of the entry, the entry is deleted.

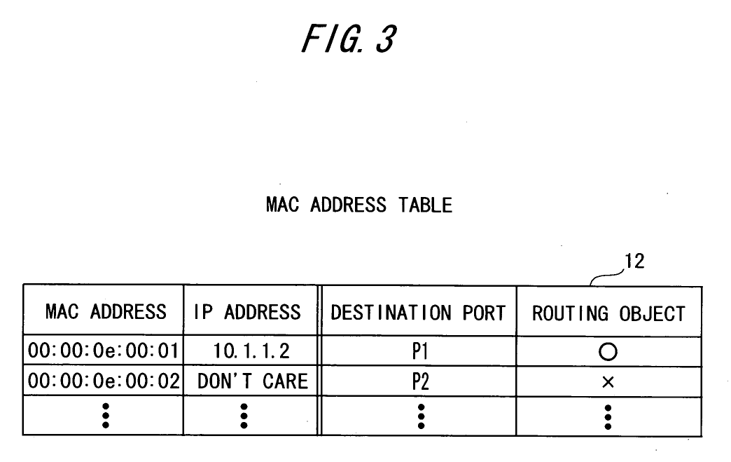

FIG. 3 is an example of the MAC address table 12 provided in the frame relay device 10. The MAC address table 12 stores a MAC address to be relayed by the frame relay device 10. The MAC address table 12 stores an IP address, a destination port, and the presence/absence of a routing object, which correspond to the MAC address.

The layer 2 address learning processing section 13 uses the allowable MAC address table 14 described below to execute a layer 2 address learning process described below for an input frame. After the layer 2 address learning process, the layer 2 address learning processing section 13 outputs the frame to the port 15 corresponding to the destination based on the layer 2 relay process. Then, the frame is sent from the port 15.

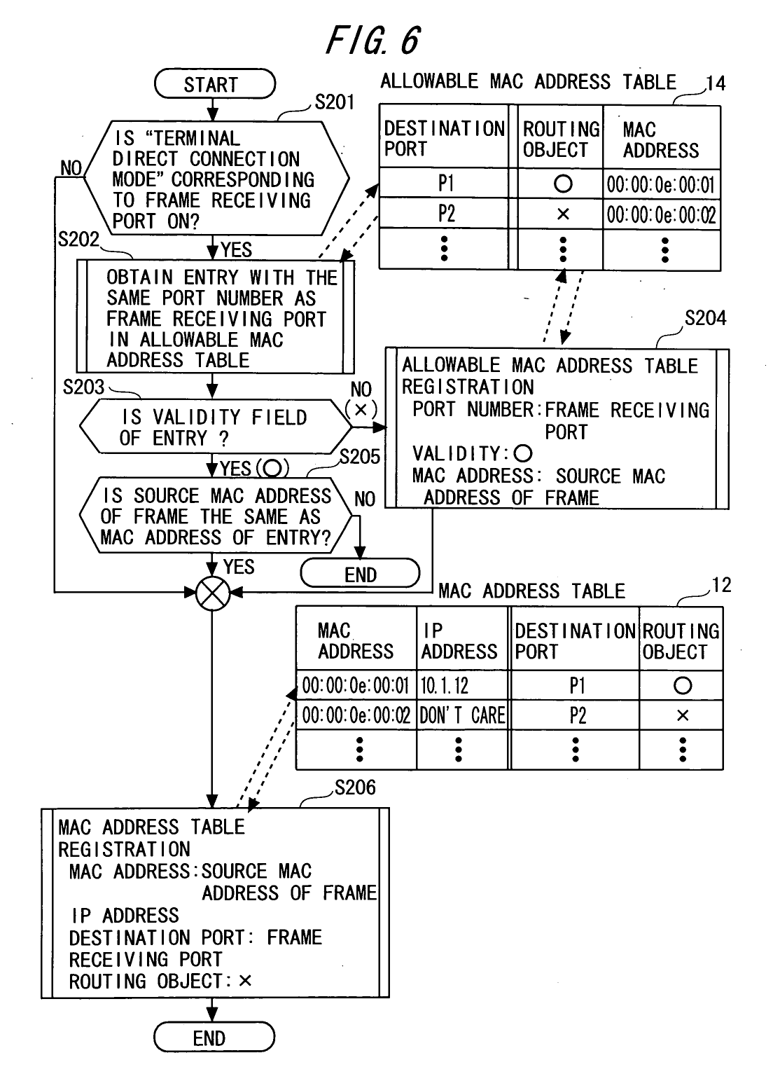

The allowable MAC address table 14 is a newly prepared table for a process executed by the layer 2 address learning processing section 13. The allowable MAC address table 14 is also prepared for preventing a learning process with a spoofed MAC address. FIG. 6 shows an example of the allowable MAC address table 14. The table 14 has an entry corresponding to each of the ports 15 included in the frame relay device 10. Each entry has a field for storing a value indicating that the MAC address is valid/invalid, which corresponds to the port number of each of the ports 15, and a field for storing a MAC address allowed to be received at the port number. In each entry, the value indicating that the MAC address is valid/invalid indicates whether or not the MAC address set in the field of the MAC address is valid.

Of the above-described structures of the frame relay device 10, the layer 2 relay processing section 11 and the layer 2 address learning processing section 13 can be realized by modifying the contents processed by the relay function and the learning function in a conventional frame relay device.

<Layer 2 Relay Device>

Next, the layer 2 relay process executed in the frame relay device 10 will be described.

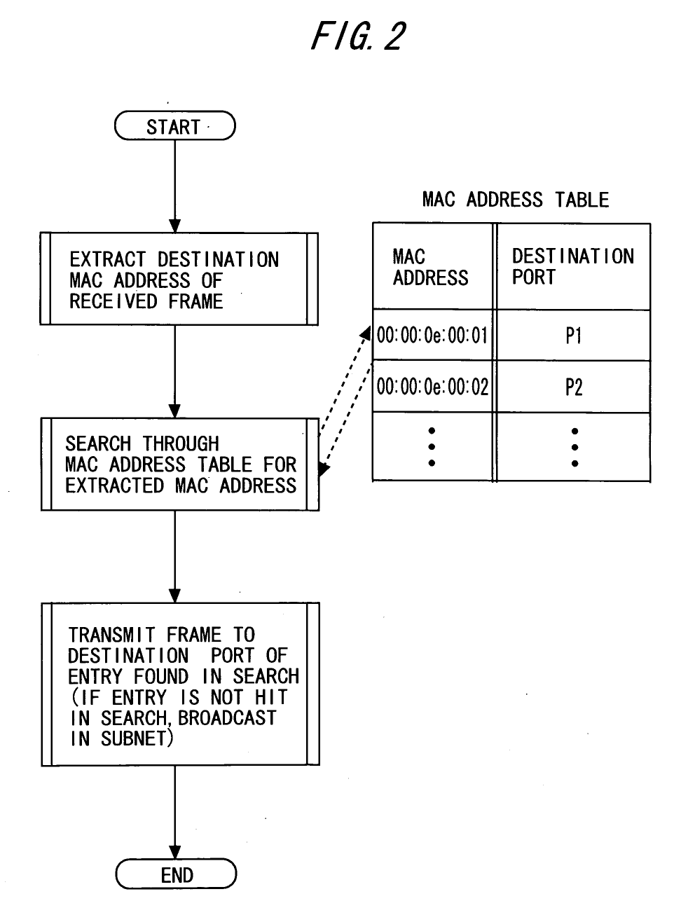

FIG. 2 is a flowchart showing the layer 2 relay process in a conventional layer 2 switch and an example of the MAC address for comparison with the present invention. In the process shown in FIG. 2, the layer 2 switch extracts a destination MAC address of a received frame and searches for a port corresponding to the destination MAC address from the MAC address table in the layer 2 switch. The MAC address table stores MAC addresses and identification information of destination ports corresponding to the MAC addresses. If the layer 2 switch successfully finds the destination port corresponding to the destination MAC address from the MAC address table (the entry having the same MAC address as the destination MAC address is hit) in the search, the frame is transmitted from the found destination port. On the other hand, if the layer 2 switch cannot find the destination port from the MAC address table (the entry is not hit) in the search, the frame is broadcasted in a subnet to which the layer 2 switch belongs.

Even conventionally, the aging process as described above was performed on the entry in the MAC address table.

In contrast to the conventional layer 2 switch as described above, the frame relay device 10 uses the MAC address table 12 to perform the following layer 2 relay process.

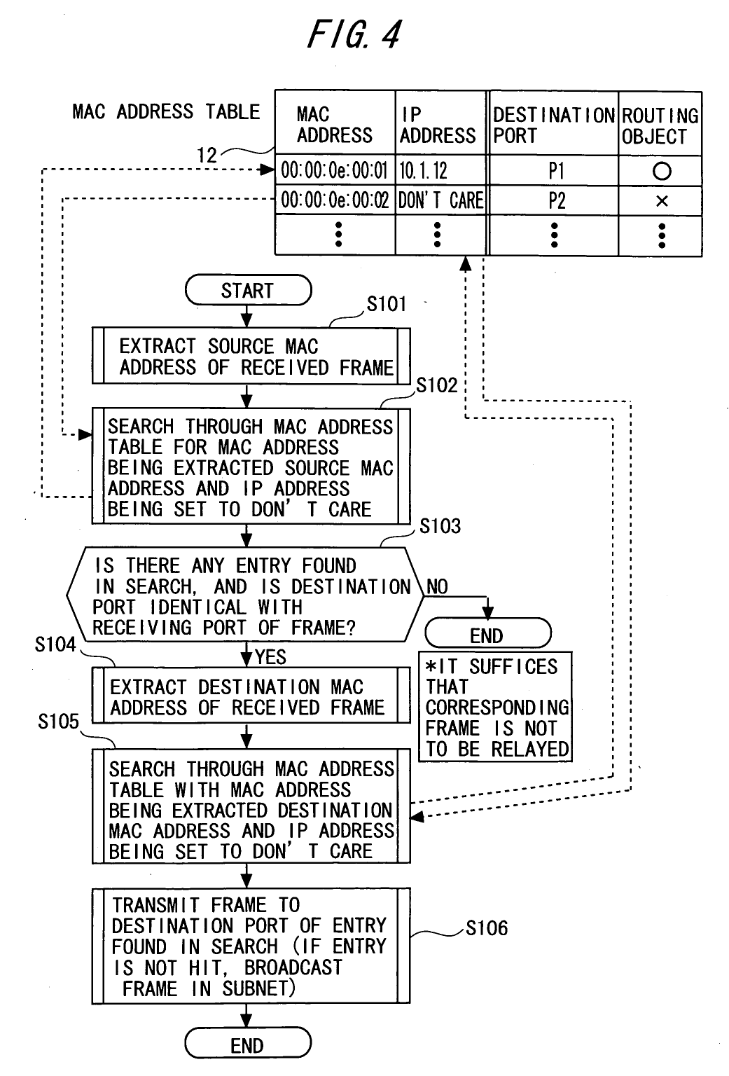

FIG. 4 is an example of a flowchart showing the layer 2 relay process by the layer 2 relay processing section 11. Upon start of the process, the layer 2 relay processing section 11 first extracts the source MAC address of the received frame (S101).

The layer 2 relay processing section 11 sets the possession of the extracted source MAC address as one of search conditions. The layer 2 relay processing section 11 also sets the non-consideration of the IP address in the layer 2 relay process (for example, “don't care”) as one of the search conditions. Then, the layer 2 relay processing section 11 searches for an entry having the same MAC address as the source MAC address from the MAC address table 12 based on the search conditions (S102).

As a result of the search through the MAC address table 12, the layer 2 relay processing section 11 judges whether or not there is information of the MAC address to be searched (the entry found in the search). Then, if the entry of the MAC address is found, the layer 2 relay processing unit 11 judges whether or not the port 15 receiving the frame is identical with the destination port of the entry in the MAC address table 12 (S103).

At this time, if both the conditions are satisfied in the process of S103 (S103: Yes), the layer 2 relay processing unit 11 performs a process of S104. If any one of the conditions is not satisfied (S103: No) in the process in S103, it is judged that the frame is not to be relayed (it is a spoofed frame) to terminate the process. The frame judged as No in S103 is not treated as a frame to be relayed in the frame relay device 10. For example, the frame is discarded in the frame relay device 10.

If both the conditions are satisfied in the process of S103, the layer 2 relay processing section 11 extracts the destination MAC address from the received frame (S104).

The layer 2 relay processing section 11 sets the extracted destination MAC address as a MAC address to be searched (sets as an entry search condition). At this time, the layer 2 relay processing section 11 sets the IP address to “don't care”, that is, does not include the IP address in the entry search conditions. Then, the layer 2 relay processing section 11 searches for the destination MAC address from the MAC address table 12 based on the search conditions (S105).

If the destination MAC address to be searched is found (the entry corresponding to the search conditions is found) as a result of the search through the MAC address table 12, the layer 2 relay processing section 11 transmits the frame to the destination port corresponding to the MAC address (S106). However, if the searched destination MAC address is not found (the entry is not hit), the frame is broadcasted in a subnet (another port other than the receiving port) connected to the frame relay device 10.

According to the above-described layer 2 relay process, as shown in FIG. 4, the judging process of S103 is added to the conventional relay process (FIG. 2). If the correspondence between the MAC address and the port is not identical with the contents registered in the MAC address table 12 in the judging process, the frame is judged as being a spoofed frame to terminate the relay process. In this manner, the process of relaying a spoofed frame can be prevented.

<Layer 2 Address Learning Process>

Next, the layer 2 address learning process executed in the frame relay device 10 will be described. The layer 2 address learning process prevents a spoofed frame from being registered in the MAC address table 12 as a frame to be relayed.

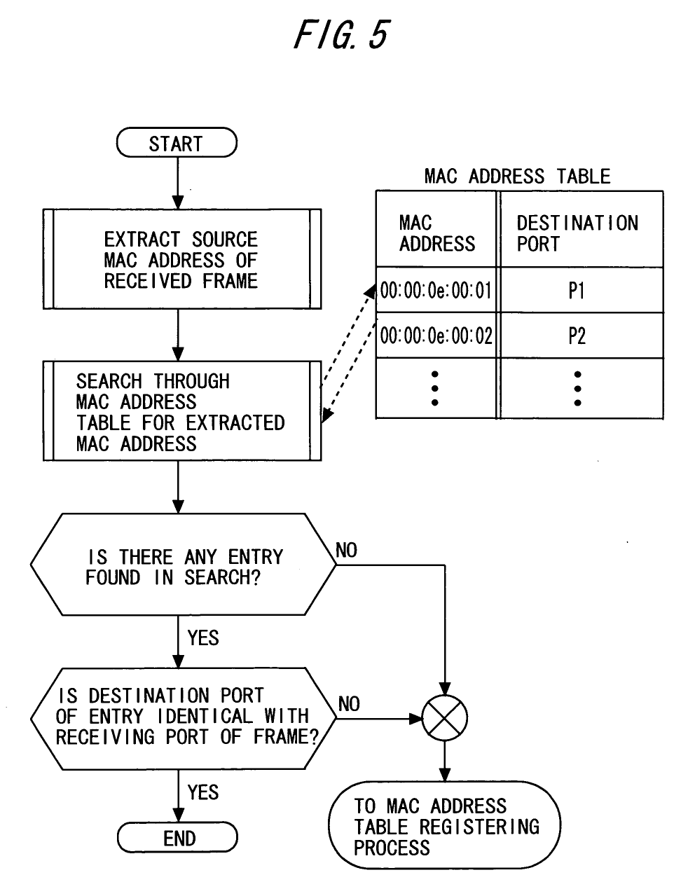

FIG. 5 is an example of a flowchart for explaining the layer 2 address learning process in the conventional layer 2 switch, for comparison with the present invention. The layer 2 address learning process is process for adding or updating a MAC address necessary for performing the layer 2 relay process to the MAC address table.

In the example shown in FIG. 5, the layer 2 switch extracts the source MAC address from the received frame to judge whether or not an entry containing the MAC address has already been registered in the MAC address table. If no corresponding entry is found or an entry containing the MAC address is found but a destination port in the entry is not identical with the receiving port of the received frame, the MAC address table registering process is performed. On the other hand, if the source MAC address and the receiving port of the frame are identical with those of the hit entry, the layer 2 switch terminates the process without performing the MAC address table registering process.

In contrast to the layer 2 address learning process of the conventional layer 2 switch as described above, the layer 2 address learning processing section 13 of the frame relay device 10 uses the MAC address table 12 and the allowable MAC address table 14 to perform the following layer 2 address learning process.

FIG. 6 is a flowchart for explaining an example of the layer 2 address learning process by the layer 2 address learning process section 13.

Upon start of the process, the layer 2 address learning processing section 13 first refers to the allowable MAC address table 14 to judge whether or not a terminal direct connection mode of the port 15 receiving the received frame is ON (S201).

In this case, the “terminal direct connection mode” indicates a mode used in the case where a terminal is directly connected (without through another HUB or switch) to one port of the frame relay device 10. The port of the frame relay device 10 is configured to be set ON/OFF for each port. When the terminal direct connection mode is ON, the layer 2 address learning processing section 13 uses the allowable MAC address table 14 to check a registerable MAC address. On the other hand, when the terminal direct connection mode is OFF, the layer 2 address learning processing section 13 does not check a registerable MAC address.

In S201, when it is judged that the terminal direct connection mode of the receiving port is not ON (is OFF) (S201: No), the layer 2 address learning processing section 13 proceeds to a process of S206. On the other hand, when it is judged that the terminal direct connection mode is ON (S201; Yes), the layer 2 address learning processing section 13 proceeds to a process of S202.

When the terminal direct connection mode is ON, the layer 2 address learning processing section 13 obtains an entry containing the same port number as that of the port 15 receiving the frame (a receiving port number) from the allowable MAC address table 14 (S202).

The frame relay device 10 is configured so that all the entries in the allowable MAC address table 14 are set “invalid” immediately after the activation of the frame relay device 10. This is for registering only an entry for the MAC address set as valid in the allowable MAC address table 14 in the MAC address table 12 because there is no registered entry in the MAC address table 12 at this time. Moreover, if the frame relay device 10 (for example, the layer 2 address learning processing section 13) recognizes that a link connected to a port Pa (a=1, 2, 3 . . . ) included in the frame relay device 10 is broken, the validity/invalidity of the MAC address for the port number Pa in the allowable MAC address table 14 is set to “invalid”. Such a process for monitoring and invalidity setting for a dead link is configured so as to be performed upon each activation of the frame relay device 10.

The layer 2 address learning processing section 13 refers to the entry obtained from the allowable MAC address table 14 to judge whether or not “valid (o)” is set in a validity/invalidity field of the entry (S203). In this step, when “valid” is set in the validity/invalidity field (S203: Yes), the layer 2 address learning processing section 13 proceeds to a process of step S205. On the other hand, when “valid” is not set in the validity/invalidity field (“invalid (x)” is set) (S203: No), the layer 2 address learning processing section 13 proceeds to a process of S204.

In S204, the layer 2 address learning processing section 13 performs a process of registering information for the frame to be processed in the allowable MAC address table 14. At this time, the layer 2 address learning processing section 13 sets “valid (o)” in the validity/invalidity field in the allowable MAC address table 14 for the entry corresponding to the port number receiving the frame. At the same time, the source MAC address of the frame is registered. When the process of S204 is terminated, the layer 2 address learning processing section 13 proceeds to a process of S206.

On the other hand, in S205, the layer 2 address learning processing section 13 judges whether or not the source MAC address of the frame is the same as the MAC address registered in the MAC address field in the entry obtained in S202. In this step, when the MAC addresses are not the same (S205: No), the layer 2 address learning processing section 13 judges the frame as being a spoofed frame to terminate the learning process. On the other hand, when the MAC addresses are the same, the layer 2 address learning processing section 13 proceeds to a process of S206.

In S206, the layer 2 address learning processing section 13 registers information for the received frame in the MAC address table 12. In this step, the layer 2 address learning processing section 13 registers as information corresponding to this frame, in the MAC address table 12, an entry with the source MAC address of the frame being set in the MAC address field of the table 12, “don't care” in the IP address field, the receiving port number of the frame in the destination port field, and information indicating a non-routing object in the field for storing information indicating whether or not it is a routing object (a flag; representable by a binary value such as “o” and “x”). After the completion of the process of S206, the layer 2 address learning processing section 13 terminates this learning process.

According to the frame relay device 10 described above, the following functions and effects can be obtained. More specifically, under the conditions where the terminal and the frame relay device 10 are directly connected to each other such that the terminal direct connection mode is set ON, the port Pa including the terminal should receive only the frame with the MAC address of the terminal being set as the source address. Therefore, in the case where the MAC address valid for the port Pa is registered in the allowable MAC address table 14, when a frame having a source MAC address different from the registered MAC address is received from the port Pa, there is a high possibility that the terminal has transmitted a spoofed frame. According to the learning process of the frame relay device 10, the learning process for such the frame is abandoned without being terminated based on the judgment of S205 to prevent the entry for the frame from being registered in the MAC address learning table 12. Moreover, according to the frame relay process of the frame relay device 10, since the process of relaying the frame is interrupted as a result of judgment of S103, the frame is never relayed.

As described above, according to the frame relay device 10, a spoofed frame can be prevented from being relayed from the terminal directly connected to the device itself. Therefore, complicated filtering setting is not needed for the relay device. Moreover, the spoofed frame can be prevented from entering the Internet or the Intranet.

Moreover, in the above-described layer 2 address learning process, the reason that the allowable MAC address table 14 does not perform a check process when the terminal direct connection mode is OFF is as follows.

When another layer 2 switch or switching HUB is connected to the frame relay device 10 in cascade arrangement, MAC addresses of a plurality of terminals connected to the another layer 2 switch get to a port of the frame relay device 10, which includes the another layer 2 switch, as the source MAC address. In this case, if the terminal direct connection mode is ON, the allowable MAC address table 14 registers only one MAC address for a single port as a valid MAC address. Therefore, the MAC addresses other than the MAC address registered as valid are not relayed. In order to prevent such the condition, under the connection condition where a frame having a plurality of normal source MAC addresses for a single port is received, the terminal direct connection mode can be set OFF.

Note that, in the above-described configuration of the frame relay device 10, after the fields for registering the IP address and information indicating whether it is a routing object or not are provided in the MAC address table 12, the processes for searching or registering the IP address are executed in FIGS. 4 and 6 (S102, S105, and S206). Such the configuration for a layer 3 may be omitted from the frame relay device 10.

### Second Embodiment

Next, a second embodiment of the frame relay device of the present invention will be described.

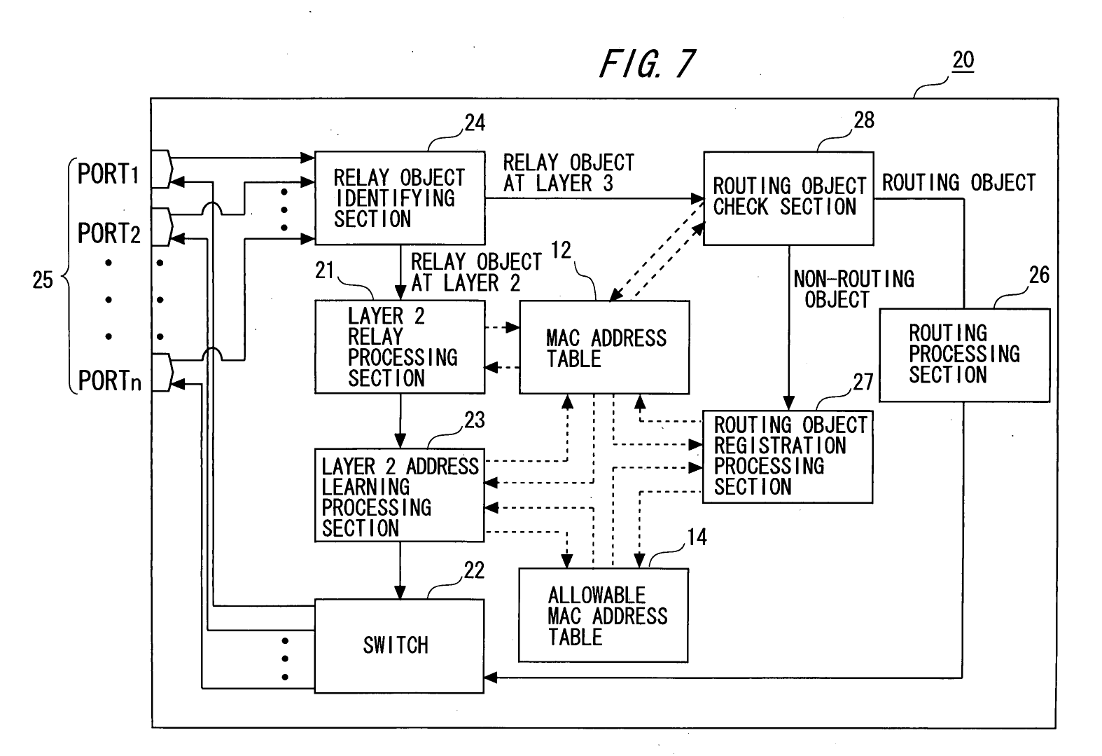

FIG. 7 is a block diagram of a configuration of a frame relay device 20 according to the second embodiment. The frame relay device 20 includes the MAC address table 12, the allowable MAC address table 14, a layer 2 relay processing section 21 (corresponding to the layer 2 relay processing means of the present invention), a switch 22, a layer 2 address learning processing section 23, a relay object identifying section 24, ports 25, a routing processing section (corresponding to the layer 3 relay processing means of the present invention) 26, a routing object registration processing section 27, and a routing object check section 28.

The routing object registration processing section 27 functions as relay object registering means of the frame relay device of the present invention. In addition, the routing object check section 28 functions as judging means of the present invention.

Of all the structures of the frame relay device 20, the structures of the layer 2 relay processing section 21, the layer 2 address learning processing section 23, and the ports 25 are the same as those of the layer 2 relay processing section 11, the layer 2 address learning processing section 13, and the ports 15 of the frame relay device 10 of the first embodiment. Therefore, in the second embodiment, the description for these functions is omitted.

The switch 22 transfers a frame to be relayed to the port determined in the layer 2 relay processing section 21 or the routing processing section 26. A switch provided for a conventional device can be used as the switch 22.

The relay object identifying section 24 judges whether each of the frame received from a plurality of (for example, n) ports 25 is to be relayed at the layer 2 or at the layer 3 based on the destination MAC address of the received frame. Note that the function of the relay object identifying section 24 may be the same as that of the conventional device.

The routing object check section 28 refers to the MAC address table 12 so as to execute a routing preprocess described below for the received frame. After the routing preprocess, the routing object check section 28 transmits the received frame to the routing processing section 26 or the routing object registration processing section 27 depending on whether the received frame is a routing object or not. The routing object check section 28 is a novel structure according to the present invention.

The routing processing section 26 performs a routing process (a layer 3 relay process) for the frame to be routed, which is received from the routing object check section 28. The routing process executed by the routing processing section 26 may be the same as a routing process executed by a conventional router.

The routing object registration processing section 27 performs a routing object registering process described below for the frame judged as not being a routing object in the routing object check section 28. The routing object registration processing section 27 is a novel structure according to the present invention.

<Routing Preprocess>

Next, the routing preprocess by the routing object check section 28 of this frame relay device 20 will be described.

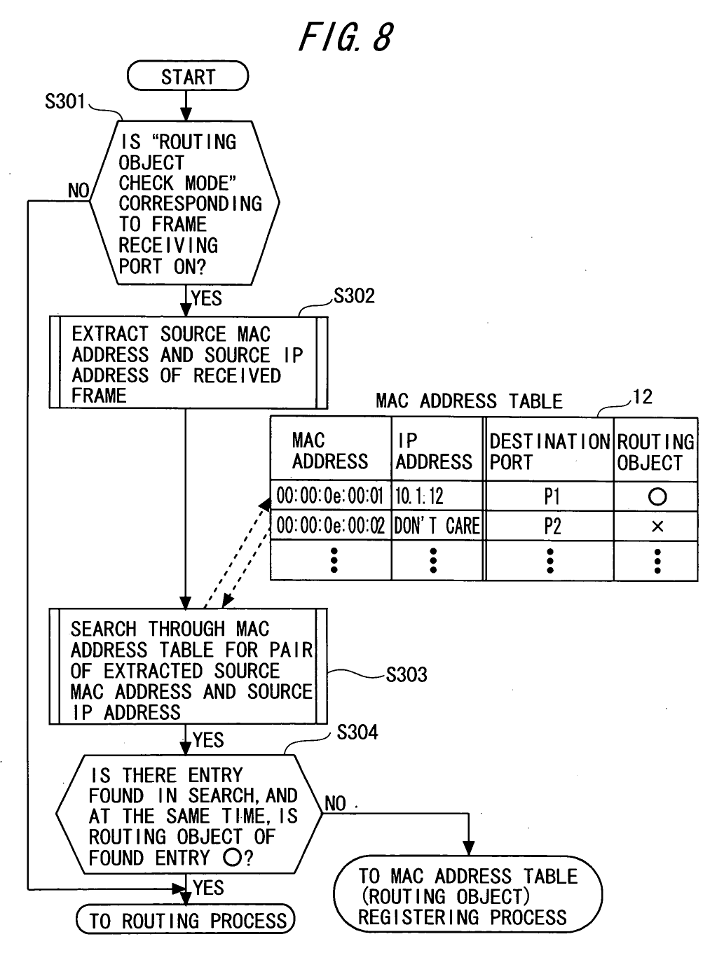

FIG. 8 is a flowchart for explaining an example of the routing preprocess by this routing object check section 28. Upon start of the preprocess, the routing object check section 28 first judges whether or not a routing object check is performed for the frame (whether or not a routing object check mode is ON) based on a received port number of the received frame (S301 of FIG. 8).

The routing object check mode will now be described. The routing object check mode corresponds to a mode in which a received frame is checked whether or not it is a routing object in the frame relay device 20 based on the pair of a source MAC address and a source IP address of the received frame. Specifically, if the routing object check mode is not set (the check mode: OFF), the received frame is not checked for whether or not it is a routing object. On the other hand, if the routing object check mode is ON, the received frame is checked for a routing object. The routing object check mode can set whether a check is to be implemented or not for each port number (ON/OFF of the mode).

In S301, when the routing object check mode is ON for the frame receiving port (S301: Yes), the routing object check section 28 proceeds to a process of S302. When the routing object check mode is OFF (S301: No), the routing object check section 28 terminates the routing preprocess to transmit the frame to the routing processing section 26. Then, a process of routing the frame is executed by the routing processing section 26. Note that, since the routing process is the same as a conventional one, the description thereof is omitted.

When the routing object check mode is ON, the routing object check section 28 extracts a source MAC address and a source IP address from the received frame (S302).

After the extraction of the source MAC address and the source IP address, the routing object check section 28 searches through the MAC address table 12 for an entry having the pair of the MAC address and the IP address (S303).

The routing object check section 28 judges whether or not there is a corresponding combination (entry) in the MAC address table 12 as a result of the search in S303. Furthermore, if the corresponding entry is found, the routing object check section 28 judges whether or not the entry is to be routed based on information (flag) in the entry found in the search, which indicates whether it is a routing object or not (S304). In this step, in either case where the entry is not found in the MAC address table 12 in the search or the frame is not a routing object (S304: No), the routing object check section 28 transmits the frame to the routing object registration processing section 27. As a result, the routing object registering process is performed by the routing object registration processing section 27 for the frame.

If the received frame satisfies both the above-described conditions (S304: Yes), the routing object check section 28 transmits the frame to the routing processing section 26.

According to the preprocess as described above, only the frame having the MAC address and the IP address respectively set as the respective source addresses to be registered as a routing object in the MAC address table 12 corresponds to an object of the routing process (relay process) by the routing processing section 26.

<Routing Object Registering Process>

Next, the routing object registering process executed by the routing object registration processing section 27 will be described.

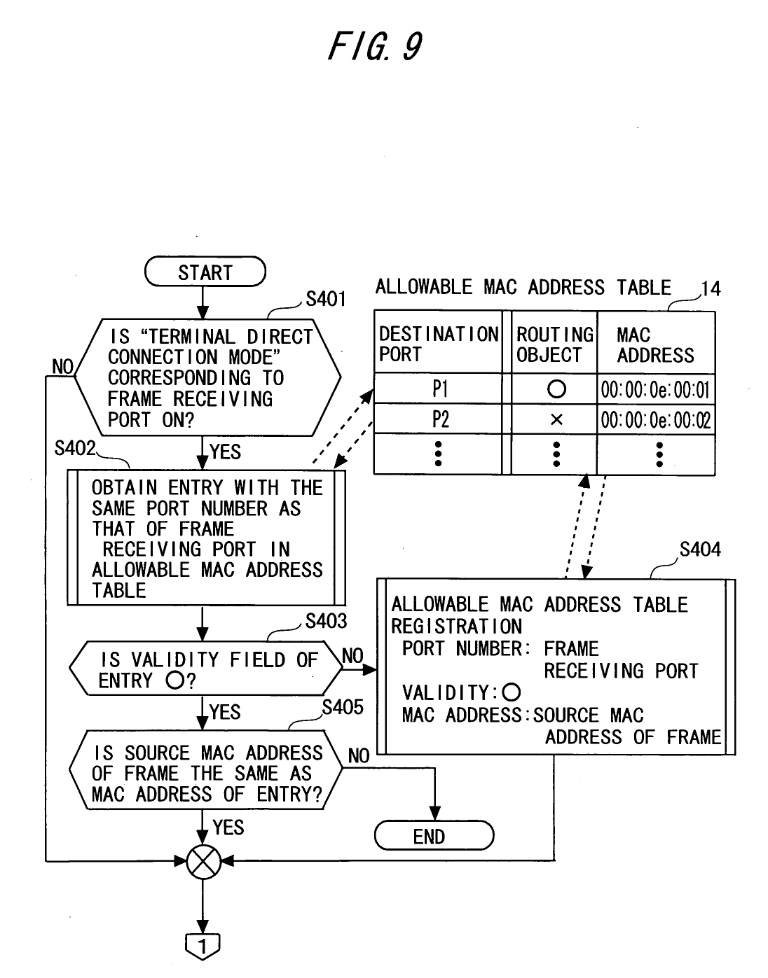

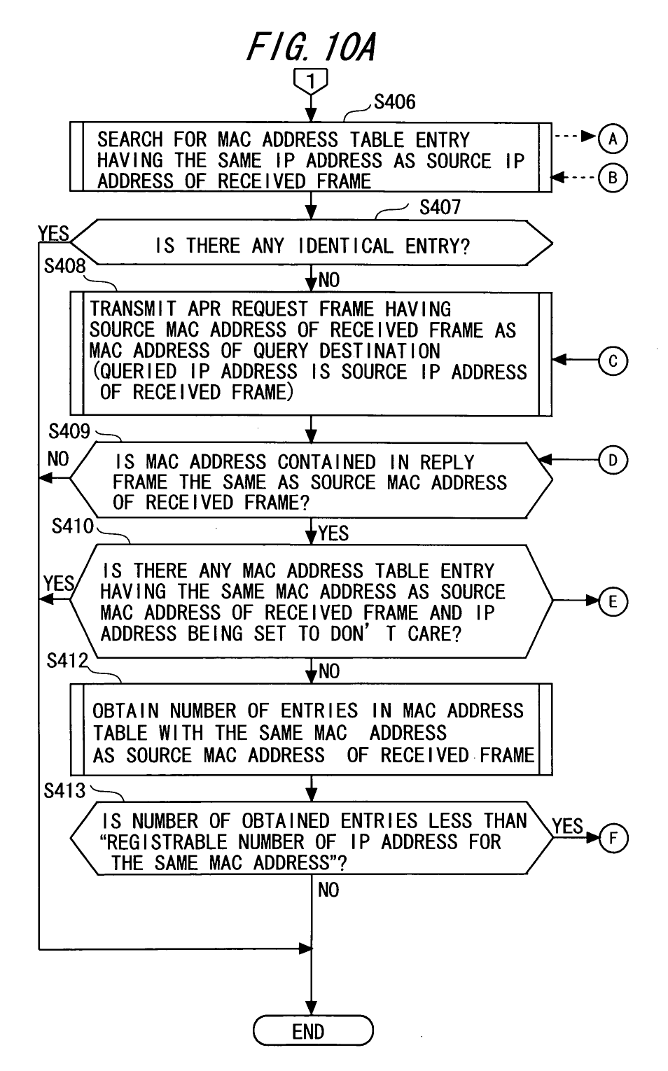

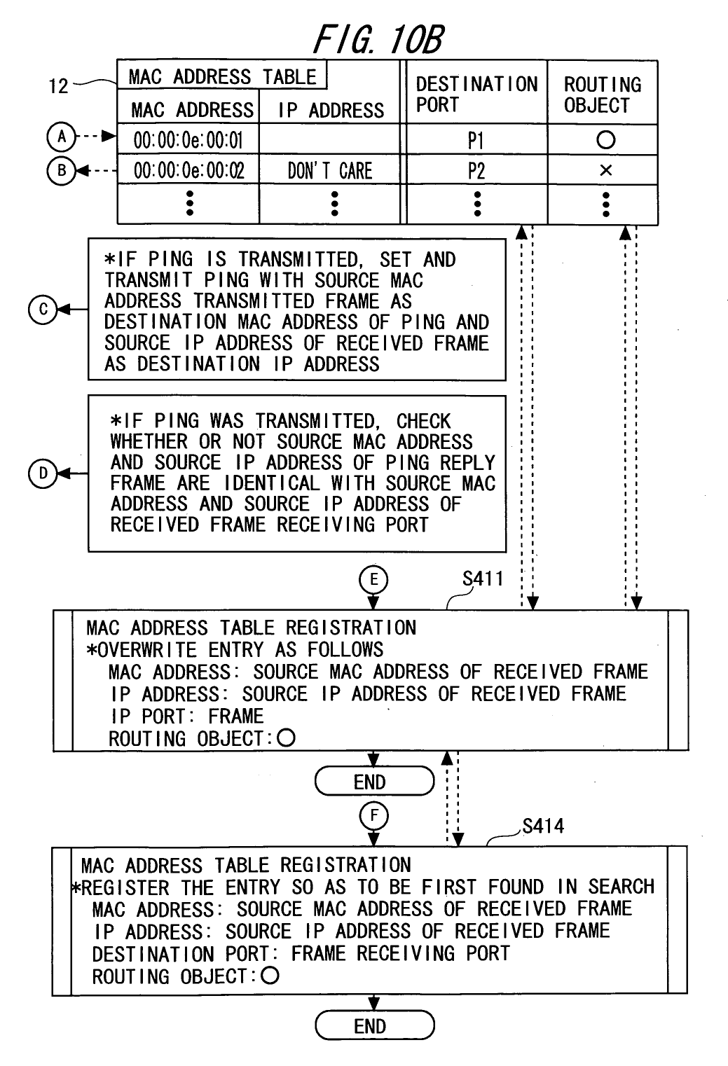

FIGS. 9, 10A and 10B are flowcharts for explaining an example of the routing object registering process by the routing object registration processing section 27.

First, the routing object registration processing section 27 judges whether or not the terminal direct connection mode corresponding to the port receiving the frame from the routing object check section 28 is ON (S401). In this step, if the terminal direct connection mode is ON (S401: Yes), the routing object registration processing section 27 proceeds to a process of S402. If the terminal direct connection mode is OFF (S401: No), the routing object registration processing section 27 proceeds to a process of S406.

If the terminal direct connection mode is ON, the routing object registration processing section 27 obtains an entry having the same port as that of the receiving port number of the received frame from the allowable MAC address table 14 (S402).

Subsequently, the routing object registration processing section 27 judges whether or not a value in a field (a validity field) for storing a value indicating valid/invalid of the MAC address contained in the entry is “valid” based on the information in the allowable MAC address table 14 (S403). In this step, if the value in the validity field is not valid (S403: No), the routing object registration processing section 27 registers the entry for the source MAC address of the frame in the allowable MAC address table 14 (S404). At this time, in the allowable MAC address table 14, a value indicating that it is valid is set in the validity field of the entry corresponding to the port number of the frame receiving port. At the same time, the source MAC address of the frame is registered in the field of storing the MAC address in the entry. After the registration, the routing object registration processing section 27 proceeds to a process of S406.

In the process of S403, if the value in the valid field of the entry found in the search is judged as being valid, the routing object registration processing section 27 judges whether or not the source MAC address of the frame is the same as the MAC address of the entry (S405). In this step, if the source MAC address of the frame and the MAC address of the entry are not the same (S405: No), the routing object registration processing section 27 judges the frame as being a spoofed frame to terminate the process without registering the frame as a routing object. On the other hand, if the source MAC address of the frame and the MAC address of the entry are the same (S405: Yes), the routing object registration processing section 27 proceeds to a step of S406.

After the processes of S401, 404, and 405, the routing object registration processing section 27 searches through the MAC address table 12 for an entry having the same IP address as the source IP address of the received frame (S406).

Then, the routing object registration processing section 27 judges whether or not the entry having the same IP address as the source IP address of the frame is found in the MAC address table 12 (S407). In this step, if there is a corresponding entry (S407: Yes), the routing object registration processing section 27 judges the frame as being a spoofed frame and terminates this process without registering the frame as a routing object.

In S407, when no corresponding entry is found in the search (S407: Yes), the routing object registration processing section 27 transmits an APR (Address Resolution Protocol) request frame having the source MAC address of the frame as a MAC address of a query destination so as to judge whether or not the frame is a spoofed frame (S408). More specifically, the APR request frame for querying a MAC address corresponding to the source IP address set in the frame is created so as to be transmitted to the source MAC address of the received frame.

The routing object registration processing section 27 judges whether or not a reply to the APR request frame is made within a predetermined time (an APR reply frame is received within a predetermined time) and, at the same time, whether or not a MAC address in the reply frame (MAC address corresponding to an IP address of the query source) is the same as the source MAC address of the received frame (S409).

If the reply frame is not received within the predetermined time or the MAC address in the reply frame and the source MAC address of the frame are not the same (S409: No), the routing object registration processing section 27 judges the received frame as being a spoofed frame and therefore terminates this process without registering the frame as a routing object.

In S408, a ping (Packet INternet Grouper) frame may be transmitted in place of the APR request frame. In this case, the source MAC address of the frame is set as a destination MAC address of the ping frame, while the source IP address of the frame is set as a destination IP address.

If the ping frame is transmitted, the routing object registration processing section 27 judges whether or not the ping reply frame is successfully received within a predetermined time and whether or not the source MAC address and the source IP address of the ping reply frame are identical with the source MAC address and the source IP address of the received frame. If the reply frame is not received within the predetermined time and the source MAC address and the source IP address of the reply frame are not identical with the source MAC address and the source IP address of the frame (S409: No), the process is terminated. Otherwise (S409: Yes), the process proceeds to S410.

In S409, if the MAC address of the query destination in the reply frame received within the predetermined time is identical with the source MAC address of the frame, that is, a normal reply to the query is obtained, the routing object registration processing section 27 judges whether or not there is any entry with the same MAC address as the source MAC address of the received frame and the setting of the IP address being “don't care” in the MAC address table 12 (S410).

In S410, if an entry satisfying the above conditions is present in the MAC address table 12 (a corresponding entry is found) (S410: Yes), the routing object registration processing section 27 rewrites (updates) the contents of the entry as follows. More specifically, the routing object registration processing section 27 registers the source MAC address of the frame in the MAC address field of the entry, the source IP address of the frame in the IP address field, the receiving port number of the frame in the destination port number field, and a value indicating that it is a routing object (a flag value, for example, o) in the field for storing information whether it is a routing object or not (S411). After the termination of S411, the routing object registration processing section 27 terminates this process.

In S410, if an entry satisfying the conditions is not present in the MAC address table 12, the routing object registration processing section 27 obtains the number of entries in the MAC address table 12, each having the same MAC address as the source MAC address of the received frame (S412).

Then, it is judged whether or not the obtained number of entries is less than a predefined registerable number of IP addresses for the same MAC address (S413). Here, the registerable number of IP addresses for the same MAC address will now be described. The registerable number of IP addresses is a value for designating the number of different IP addresses corresponding to the same MAC address (entries, each having the same MAC address but a different IP address), which are allowed to be registered. For example, if 2 is set as the registerable number of IP addresses, it is indicated that two entries having a common MAC address but different IP addresses can be registered at a maximum in the MAC address table 12. Note that the registerable number of IP addresses is prepared in advance on a memory (not shown) accessible by the routing object registration processing section 27. The registerable number can be modified through a user interface or the like.

In S413, if the number of obtained entries is less than the registerable number of IP addresses, the routing object registration processing section 27 registers the entries for the frame in the MAC address table 12. More specifically, the entry with the source MAC address of the frame being set in the MAC address field of the entry, the source IP address of the frame being set in the IP address field, the receiving port number of the frame being set in the destination port number field, and a value indicating that the frame is a routing object being set in the field for storing a value indicating that it is a routing object or not is registered in the MAC address table 12 (S414). Then, after finishing writing the MAC address table 12, the routing object registration processing section 27 terminates this process.

In S413, if the number of obtained entries is equal to or larger than the registerable number of IP addresses (S413: No), it is judged that it is no longer possible to register IP addresses for the entry, that is, there is a possibility that the frame is a spoofed one. Therefore, this process is terminated without registering the frame.

The entry added to the MAC address table in the above-descried S414 is registered in a state where it is first searched (hit) or in a state where it is searched (referred to) prior to the already registered other entries having the same MAC address as that of the added entry in the above-described preprocess or the layer 2 relay process. The reason for this is as follows. Normally, one source IP address corresponds to the source MAC address. Therefore, if only one entry (one IP address) is allowed to be registered in the MAC address table 12 for one MAC address, an entry can be subsequently prevented from being registered for a frame with a spoofed IP address (a different IP address) subsequently. On the other hand, it is not totally unexpected that the IP address used by the terminal may be properly modified by setting or the like. Therefore, the registerable number of IP addresses can be set to 2 or larger, thereby allowing a plurality of entries, each having a common MAC address but a different IP address, to be registered in the MAC address table 12. However, since the terminal normally uses one IP address, the IP address before modification is no longer used once the IP address is modified. On the other hand, as described above, an entry that is not used for a predetermined time is deleted from the MAC address table 12 by the aging process. Thus, as described above, if the added entry is registered so as to be hit in a search prior to the other entries containing the IP address before modification, the other entries can be automatically deleted by the aging process.

Note that, in the above-described process of S413, although the number of entries is judged to be less than the registerable number or not, the number of entries may be judged to be equal to or less than the registerable number or not. Specifically, it is sufficient that the number of entries containing a common MAC address, which is larger than the registerable number, are not registered in the MAC address table 12.

Moreover, in the routing object registering process, the allowable MAC address table is checked only when the terminal direct connection mode is ON so as to cope with the case where a layer 2 switch or the like instead of a terminal is connected to the port in cascade arrangement. This is the same reason as that described in the first embodiment.

<Effects of the Embodiments>

According to the above-described first and second embodiments relating to the frame relay device of the present invention, the following effects can be obtained.

Referring to FIG. 5, when the terminal direct connection mode is ON, only the MAC address allowed in the allowable MAC address table is to be learned. If a terminal directly connected to the frame relay device 10 or 20 spoofs a MAC address, the learning process is not performed for the spoofed MAC address because a MAC address communicated up to then has been already registered in the allowable MAC address table. In other words, since the entry is not registered in the MAC address table, the effect that a spoofed MAC address is not relayed as shown in the relay method in FIG. 4 can be obtained.

Moreover, when a link is broken, the allowable MAC address table 14 sets invalid as validity/invalidity setting for a port having the link. Therefore, for example, when a connection is modified to be made to another terminal, validity/invalidity of the MAC address in the entry for the port is set invalid in the allowable MAC address table 14. Therefore, the MAC address at the time when the terminal starts communicating is reregistered. Accordingly, according to the frame relay devices 10 and 20, even if a user changes or moves a terminal for one port (changes a port), address spoofing can be coped with.

Moreover, for example, in the frame relay devices 10 and 20, in the case where MAC addresses of a plurality of terminals situated downstream of another layer 2 switch to be connected reach as a source MAC address, only one of the terminals under control of the layer 2 switch is allowed to communicate by the check process of the allowable MAC address table when the terminal direct connection mode is set ON. Therefore, in the frame relay devices 10 and 20 of the present invention, the terminal direct connection mode is set OFF so that all the MAC addresses from the port can be registered in the MAC address table. In this manner, the communication from all the terminals can be ensured.

<Variations>

For the frame relay devices 10 and 20 according to the embodiments of the present invention, for example, the following variations or operations are possible.

For example, if another layer 2 switch or the like is connected to the frame relay device 10 or 20 in cascade arrangement, the terminal direct connection mode has to be set OFF. In this case, however, a check for MAC address using the allowable MAC address table 14 is not performed. Therefore, in order to obstruct a frame with a spoofed MAC address coming from a port to which the another layer 2 switch is connected, the layer 2 switch is replaced by the frame relay device 10 so that the terminal is connected so as to be directly coupled to the frame relay device 10. As a result, a spoofed frame can be prevented from being relayed in the frame relay device 10.

Moreover, the frame relay device 20 checks a routing object only when the routing object check mode is ON. This is for coping with the case where another layer 3 relay device (a router, a layer 3 switch, or the like) is connected to the port 25. If another layer 3 relay device is connected to the frame relay device 20, MAC addresses of frames coming from the other relay device (routing frames) are all MAC addresses of the other relay device. Therefore, the frame relay device 20 receives a large number of source IP addresses for the same source MAC address. Specifically, if a large number of source IP addresses are present for the same source MAC address, the frame is judged as being spoofed in the frame relay device 20 and therefore is not a routing object. In this case, the routing object check mode is set OFF for the port 25 so as to be able to deal with a connection between routers.

However, if the routing object check mode is set OFF in the frame relay device 20, IP address or MAC address spoofing cannot be prevented. In this case, the layer 3 relay device to be connected is replaced by the frame relay device 20. The replacement can prevent a spoofed frame from being relayed in the replaced frame relay device 20.

Moreover, in the frame relay device 20, a modified conventional address table is used as the table for judging whether or not it is a routing object. As a result, the device configuration can be simplified, while the aging function conventionally provided for the relay device can be used to delete an unnecessary entry. However, a table for registering information for judging allowance/non-allowance of routing (an object or not) may be provided independently of the MAC address table. In this case, however, the automatic deleting function for old entries (automatic deletion is incorporated into the MAC address table so as to be realized by the aging process at the layer 2) is no longer available. Therefore, it is necessary to add the aging process to the separately created table independently of the MAC address table. The aging process method of this case may be the same as the aging process of the layer 2 relay process.

In order to prevent the case where the MAC address and the IP address are both spoofed and a false reply to the ARP or the ping is made, it is sufficient that the processes as shown in FIGS. 4 and 5 are executed along with the routing object registering process in the frame relay device 20. In this manner, the frame with the MAC address and the IP address being both spoofed can be perfectly prevented from being relayed.

Furthermore, the frame relay device 20 has been described supposing the case where the IP is an IPv4. However, the frame relay device can cope even with the case where the IP is an IPv6 without modifying the process. More specifically, if the IPv6 is used, the size of the field of storing the IP address in the MAC address table is expanded from 32 bits for the IPv4 to 128 bits for the IPv6. Moreover, in S408 shown in FIGS. 10A and 10B, as a frame transmitted for checking the MAC address, a neighbor solicitation message of an ICMPv6 is transmitted in place of the APR frame. Then, a neighbor advertisement message may be waited for in place of the ARP reply message. In this case, the judging process of S409 remains unchanged. In this case, the frame relay device according to the present invention can deal with not only the IPv4 but also the IPv6.

### INDUSTRIAL APPLICABILITY

The present invention can be applied to the industry that provides a frame relay process for preventing address spoofing.

### Others

The disclosures of international application PCT/JP2003/012828 filed on Oct. 7, 2003 including the specification, drawings and abstract are incorporated herein by reference.

1. A frame relay device, comprising:
a table for registering an entry containing a pair of a MAC address and an IP address used in a process of relaying a frame in the frame relay device itself;
judging unit for searching through the table for a source MAC address and a source IP address in a received frame to judge whether or not the pair of the source addresses is registered as a relay object at a layer 3; and
layer 3 relay processing unit for performing a layer 3 relay process only for a frame judged as containing the pair of the source addresses registered as the relay object.

2. The frame relay device according to claim 1, further comprising relay object registering unit for: transmitting a query frame for querying whether or not the pair of the source addresses is normal if the pair of the source addresses of the frame is not registered in the table; judging whether or not a condition that a reply frame to the query frame is received within a predetermined time after the transmission of the query frame and a condition that information in the reply frame indicates that the pair of the source addresses is normal are satisfied; registering an entry containing a pair of source addresses satisfying the conditions in the table; and excluding a pair of source addresses failing to satisfy the conditions from an object to be registered in the table.

3. The frame relay device according to claim 2, wherein the relay object registering unit transmits an APR request frame for querying a MAC address corresponding to the source IP address of the frame as the query frame to receive an ARP reply frame as the reply frame and judges that the combination of the source addresses is normal when the MAC address of a query destination in the ARP reply frame is identical with the source MAC address of the frame.

4. The frame relay device according to claim 2, wherein the relay object registering unit transmits a ping frame containing the source MAC address and the source IP address of the frame respectively as a destination MAC address and a destination IP address as the query frame to receive a ping reply frame as the reply frame and judges that the combination of the source addresses is normal when the source MAC address and the source IP address of the ping reply frame are respectively identical with the source MAC address and the source IP address of the frame.

5. The frame relay device according to any one of claim 2, wherein the relay object registering unit excludes the pair of the source addresses of the frame from an object to be registered in the table regardless of whether or not the conditions for the reply frame are satisfied when an entry containing the same IP address as the source IP address of the frame is already registered in the table.

6. The frame relay device according to any one of claim 2, wherein the relay object registering unit excludes the pair of the source addresses of the frame from an object to be registered in the table regardless of whether or not the conditions for the reply frame are satisfied when an entry containing the same MAC address as the source MAC address of the frame is already registered in the table.

7. The frame relay device according to any one of claims 2, wherein:
a registerable number of entries having the same MAC address and a different IP address in the table is predefined; and
wherein the relay object registering unit excludes the pair of the source addresses of the frame from an object to be registered in the table regardless of whether or not the conditions for the reply frame are satisfied when the number of entries equal to or larger than the registerable number, each containing the same MAC address as the source MAC address of the frame, are already registered in the table.

8. The frame relay device according to any one of claim 1, wherein the table stores an entry containing a MAC address and a destination port number corresponding to the MAC address and is constituted by providing a field of an IP address corresponding to the MAC address and a field for storing information indicating whether or not it is a relay object for each entry of the MAC address table referred to so as to find a destination port in the layer 2 relay of a frame,
the frame relay device further comprising:
layer 2 relay processing unit for referring to the table to perform the layer 2 relay process of a frame received by the frame relay device itself; and
deleting unit for deleting an entry unused for a given period of time from the table.

9. The frame relay device according to claim 8, wherein, when an entry containing the pair of the source addresses of the frame is to be registered in the table, if another entry containing the same MAC address as the MAC address forming the pair of the source addresses is already registered in the table, the entry is registered so as to be found in a search prior to the another entry in a process executed by the judging unit.

10. The frame relay device according to any one of claim 1, wherein the frame relay device is configured to be capable of setting whether or not the processes executed by the judging unit and the relay object registering unit are performed for each port included in the frame relay device itself.

11. A framed relay device, comprising:
a table capable of registering only one receivable MAC address for each port included in the frame relay device itself;
judging unit for judging, for a frame received at each port, whether or not a pair of the same MAC address and the same port number as a pair of a source MAC address and a receiving port number of the frame is registered in the table; and
relay unit for performing a layer 2 relay process only for a frame containing the pair of the source MAC address and the receiving port number judged as being registered.

12. The frame relay device according to claim 11, further comprising a MAC address learning section for judging whether or not the pair of the source MAC address and the receiving port number is valid to register a valid pair of a source MAC address and a receiving port number in the table when the source MAC address of the frame is not registered in the table.

13. The frame relay device according to claim 12, wherein the MAC address learning section registers a pair of a source MAC address and a receiving port number of a frame first received after the port is brought into a frame receivable state as the valid pair in the table.

14. The frame relay device according to claim 11, wherein the MAC address learning section is capable of setting for each port number whether or not to judge validity of the pair of the source MAC address and the receiving port number.

15. A frame judging device, comprising:
a table capable of registering only one receivable MAC address for each port included in the frame judging device itself; and
judging unit for judging, for a frame received at each port, whether or not a pair of the same MAC address and the same port number as a pair of a source MAC address and a receiving port number of the frame is registered in the table.

16. A frame judging device, comprising:
a table for registering an entry containing a pair of a MAC address and an IP address used in a process of relaying a frame in the frame judging device itself; and
judging unit for searching through the table for a source MAC address and a source IP address in a received frame to judge whether or not the pair of the source addresses is registered as a relay object at a layer 3.
